(19) United States
(12) Patent Application Publication
(10) Pub. No.: US 2016/0092934 A1
(43) Pub. Date: Mar. 31, 2016

(54) METHOD AND SYSTE OF ADVERTISING ON TAKEOUT BOXES AND TO GO CONTAINERS

(71) Applicant: John J. MORANO, Fort Myers, FL (US)

(72) Inventor: John J. MORANO, Fort Myers, FL (US)

(21) Appl. No.: 14/332,699

(22) Filed: Jul. 16, 2014

(51) Int. Cl. G06Q 30/02

(52) U.S. Cl. CPC G06Q 30/0276

(57) ABSTRACT

A method of advertising on takeout containers, or “adgoboxes,” is provided. The adgoboxes may be any known container for storing and transporting consumer goods, such as takeout food, wherein the container has an exterior surface on which at least one advertisement may be affixed. A user of the method may be an advertising organization, whereby the advertising organization may design and provide the adgoboxes at no cost to predetermined providers of said consumer goods.

### CROSS-REFERENCE TO RELATED APPLICATION

This application claims the benefit of priority of U.S. provisional application No. 61/924,363, filed 7 Jan. 2014, the contents of which are herein incorporated by reference.

### BACKGROUND OF THE INVENTION

The present invention relates to advertising methods and systems and, more particularly, to advertising on takeout food containers.

Annually, billions of dollars are spent by advertisers in an attempt to make the public and potential customers aware of their product and service offerings. Similar numbers are associated with the annual purchases of takeout or ‘to go’ food. Moreover, the food service industry is always looking for netting more income.

As can be seen, there is a need for a symbiotic method in which organizations can advertise on the take-out food containers of third party food service providers.

### SUMMARY OF THE INVENTION

In one aspect of the present invention, system for advertising on takeout containers, comprising: a computer having a user interface; and a program product comprising machine-readable program code for causing, when executed, the computer to perform the following process steps: producing an electronic representation of a plurality of commercial providers each comprising at least one takeout container type used and a plurality of predetermined data pertaining to their commercial activities; prompting an organization to select at least one commercial provider for advertising via the user interface; prompting the user to specify a design concept and an advertising format for at least one takeout container; sending an electronic representation of the design concept and the advertising format for at least one takeout container to the selected at least one commercial provider via the user interface; and receiving approval from the selected at least one commercial provider regarding the design concept and an advertising format for at least one takeout container.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of an adgobox of the present invention;

FIG. 2 is a perspective view of an exemplary embodiment of the adgobox of the present invention;

FIG. 3 is a perspective view of an exemplary embodiment of the adgobox of the present invention;

FIG. 4 is a perspective view of an exemplary embodiment of the adgobox of the present invention, shown in use;

FIG. 5 is a top view of an exemplary embodiment of the adgobox of the present invention;

FIG. 6 is a section view of an exemplary embodiment of the adgobox of the present invention along line 6-6 in FIG. 5;

FIG. 7 is an enlarged detailed section view of an exemplary embodiment of a portion of the adgobox of the present invention; and

FIG. 8 is a flowchart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a method of advertising on takeout containers, or “adgoboxes.” The adgoboxes may be any known container for storing and transporting consumer goods, such as takeout food, wherein the container has an exterior surface on which at least one advertisement may be affixed. A user of the method may be an advertising organization, whereby the advertising organization may design and provide the adgoboxes at no cost to predetermined providers of said consumer goods.

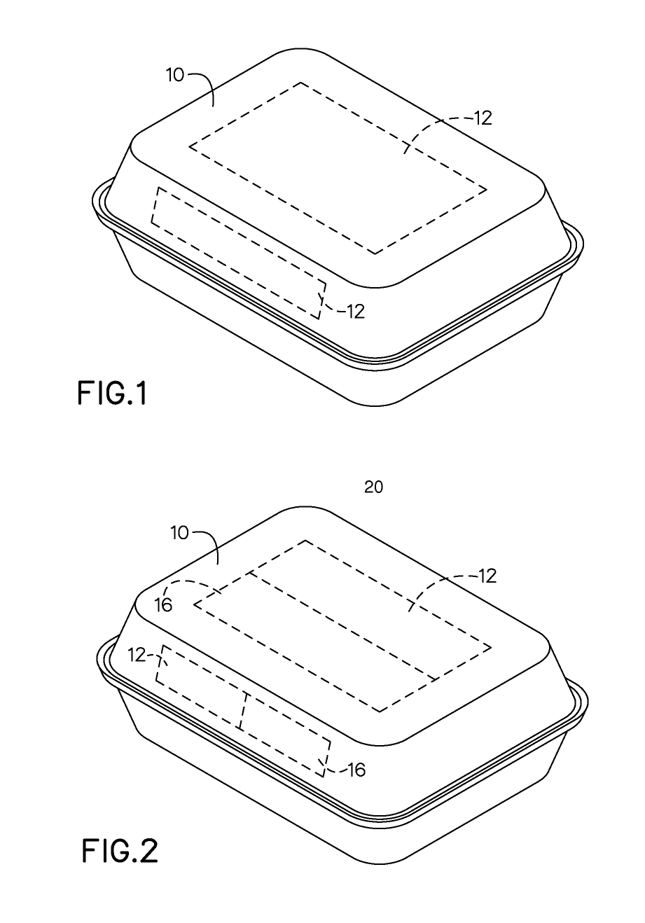

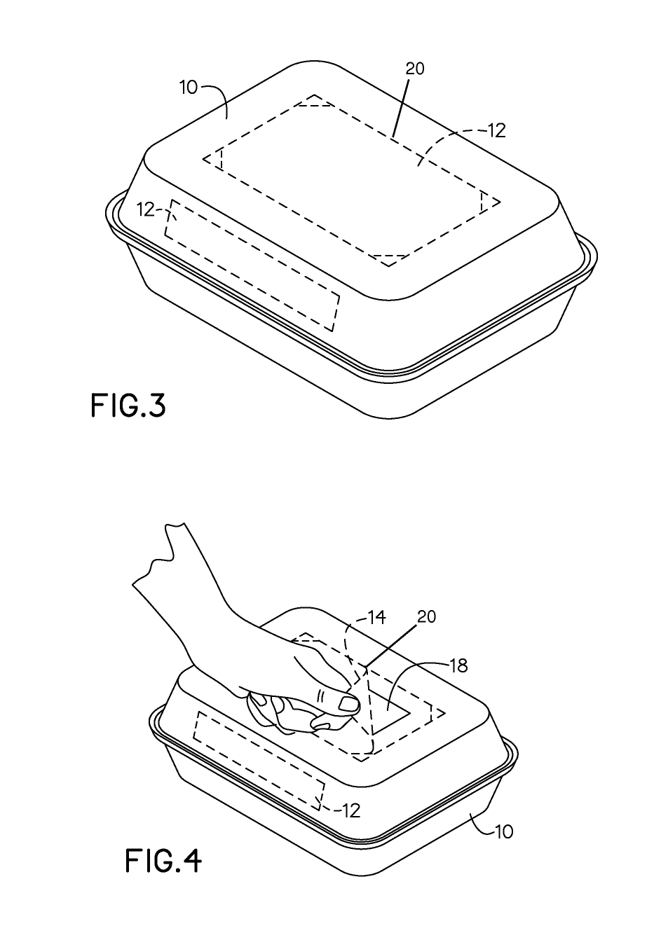

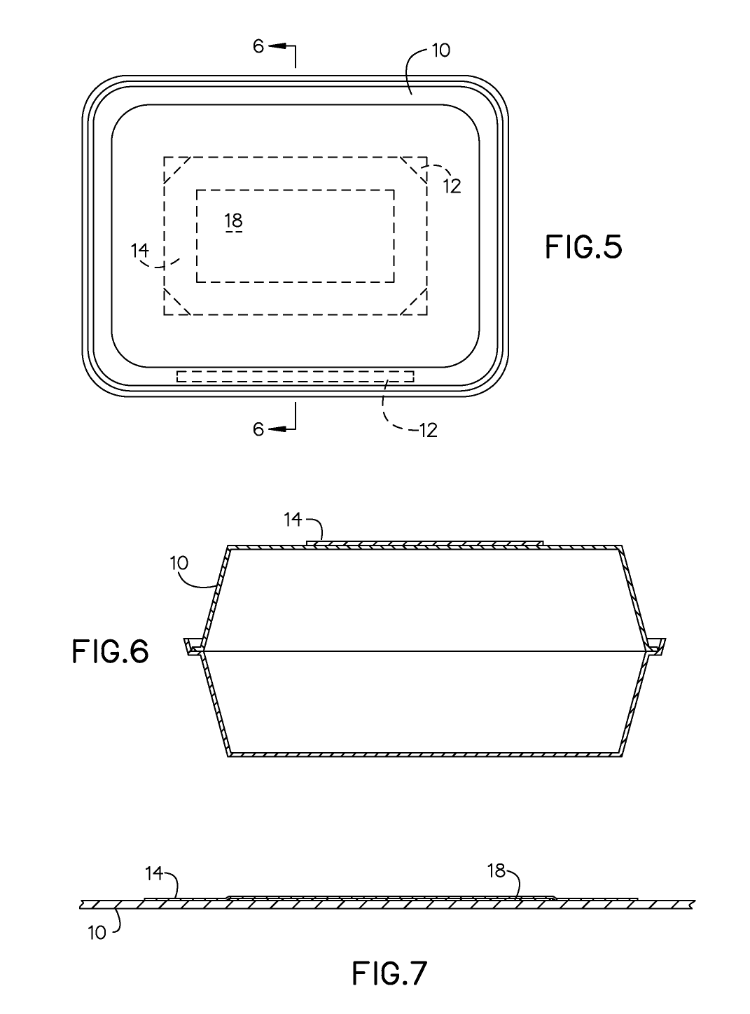

Referring to FIGS. 1 through 7, the present invention may include an adgobox 10. The adgobox 10 may include any known container for storing and transporting consumer goods such as takeout food, including pizza boxes, Chinese food boxes, deli takeout containers and the like. The adgobox 10 may not be limited to a box-like shape. Nor may the adgobox 10 be limited to container of food stuff, and so going forward it should be understood that the use of such terms as “takeout container” and the like are not meant to be limiting. The adgobox 10 may be made of material, such as polystyrene foam, styrene, laminated fibrous materials, various plasticized materials, and their organic, environmentally-friendly equivalents, sufficient to hold and insulate food at a desired temperature.

The adgobox 10 may include an interior surface defining a compartment for accommodating the takeout food. The adgobox 10 may include an exterior surface suitable for integrating and/or affixing at least one advertisement 12 thereto. The at least one advertisement 12 may include, but not be limited to displays 16, sealed pouches, company logo, trademark, promotional writing, slogan, at least one removable solicitation 18, discounts, or other advertising features of direct mail advertisement. The at least one removable solicitation 18 may include coupons, tickets, agreements, promotional offers and the like.

In certain embodiments, the at least one advertisements 12 may include an ad pocket 14. The ad pocket 14 may be a display sheet of transparent material having a front sheet edge, wherein a portion of the front sheet edge and the exterior surface may be connected along a closed portion of the front sheet edge and the exterior surface forming the ad pocket 14 in between the exterior surface and the display sheet. An opening to the ad pocket 14 may be formed along an open portion of the front sheet edge and the exterior surface where the front sheet edge is not connected. The at least one advertisement 12 may be placed within the ad pocket 14 of the adgobox 10. In certain embodiments, the opening of the ad pocket 14 may include a perforated seal. In an alternative embodiment, the entire front sheet edge and the exterior surface may be connected along a perforated seal. The perforated seal may be adapted to provide evidence if the perforated seal is broken or otherwise tampered with so that it can be readily ascertained that an end user (customer) was the first to access the ad pocket 14.

It should be understood that the at least one advertisements 12 may be affixed to the interior surface and/or exterior surface by any known means in the art for fastening or removably securing one object to another including, for example, Velcro-type fasteners, adhesive substances, pockets, sealed pouches, framing, combinations thereof, and the like.

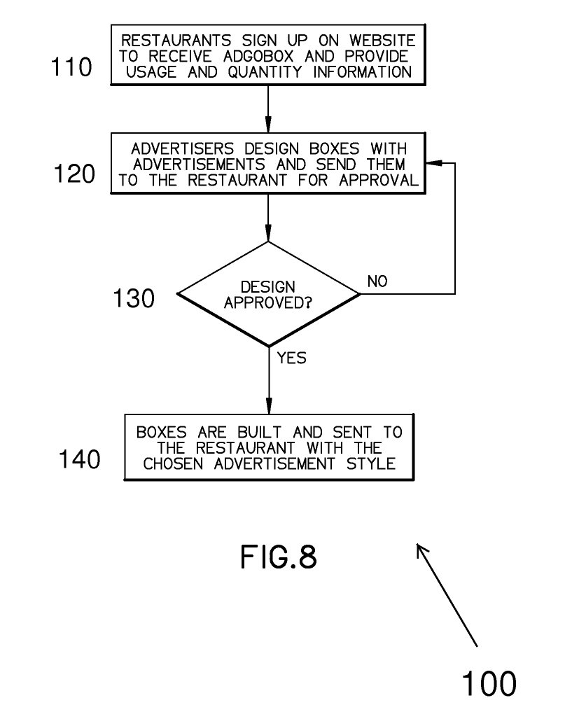

Referring the FIG. 8, the present invention may include at least one computer with a user interface. The computer may include any processing element and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

A method of using the present invention may include the adgobox 10 disclosed above. A method of advertising on to go boxes and takeout containers 100 may be initiated by a commercial provider registering with an adgobox database, in step 110. The commercial provider may include food service providers, including restaurants, delis and the like. The commercial provider may be prompted to input identifying information as well as predetermined data relating to the matter, type and scope of consumer goods and services that they currently provide, including the type of takeout boxes they use and demographic information on their clientele. Then organizations, including business concerns, non-profits, advertisers and the like may access the adgobox database and be prompted to input identifying information as well as predetermined data relating to the matter, type and scope of consumer goods and services that they currently provide, including demographic information regarding prospective customers.

In certain embodiments, the program product may determine whether the at least one organization is a good match for at least one commercial provider based on similarity of the predetermined data of each. The program product may provide at least one determined match if there is substantial similarity between the respective predetermined data. In an alternative embodiment, the organizations may search out prospective registered commercial providers via a key term search engine provided by the program product so as to self select the determined match.

The determined matched organization may be prompted to input the number of adgoboxes 10 to be supplied, suggested design elements of at least one adgobox 10 and associated suggested at least one advertisement 12 thereof for approval by the determined match commercial provider, in step 120. The suggested at least one advertisement 12 may denote the specific format and number of advertising features to be provided. The program product may determine a cost of such suggested design elements of at least one adgobox 10 and associated suggested at least one advertisement 12 for consideration of the determined matched organization.

The determined match may receive the suggested design elements of at least one adgobox 10 and associated suggested at least one advertisement 12 for approval, in step 130. If the approval is denied, then the organization may revisit step 120 to resubmit new design elements of at least one adgobox 10 and associated at least one advertisement 12 to the same determined match commercial provider, or alternatively find a new determined match commercial provider by revisiting step 110.

If the suggested design elements of at least one adgobox 10 and associated at least one advertisement 12 are approved, then the resulting adgoboxes 10 are constructed, the cost to be paid by the determined match organization, in step 140. Such constructed adgoboxes 10 are sent to the at least one determined match commercial provider.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for advertising on takeout containers, comprising:
a computer having a user interface; and
a program product comprising machine-readable program code for causing, when executed, the computer to perform the following process steps:
producing an electronic representation of a plurality of commercial providers each comprising at least one takeout container type used and a plurality of predetermined data pertaining to their commercial activities;
prompting an organization to select at least one commercial provider for advertising via the user interface;
prompting the user to specify a design concept and an advertising format for at least one takeout container;
sending an electronic representation of the design concept and the advertising format for at least one takeout container to the selected at least one commercial provider via the user interface; and
receiving approval from the selected at least one commercial provider regarding the design concept and an advertising format for at least one takeout container.
